(19) United States
(12) Patent Application Publication
(10) Pub. No.: US 2026/0251170 A1
(43) Pub. Date: Aug. 27, 2026

(54) Snap-In Retainer System

(71) Applicant: Illinois Tool Works Inc., Glenview, IL (US)

(72) Inventor: Joel R. Lee, Peotone, IL (US)

(21) Appl. No.: 19/543,242

(22) Filed: Feb. 18, 2026

Related U.S. Application Data
(60) Provisional application No. 63/762,830, filed on Feb. 25, 2025.

(51) Int. Cl. F16B 21/08; F16B 2/22

(52) U.S. Cl. CPC F16B 21/086; F16B 2/22

(57) ABSTRACT

A fastener assembly includes a first component defining a passageway and a second component receivable within the passageway. One of the first component and the second component includes at least one resilient retention member, and the other includes at least one engagement feature. The resilient retention member is configured to deflect during insertion of the second component into the passageway and to engage the engagement feature to retain the second component relative to the first component. The retention interface permits secure axial retention while allowing removal upon application of a predetermined extraction force.

### CROSS-REFERENCE

The present application claims priority to U.S. Provisional Patent Application No. 63/762,830, filed Feb. 25, 2025, and entitled “Snap-In Retainer System,” which is hereby incorporated by reference in its entirety.

### BACKGROUND

Automotive assemblies commonly rely on fastening techniques that are economical to manufacture, straightforward to assemble, and capable of providing secure and reliable retention under operational loads. In many applications, a secondary panel or trim component must be secured to a primary panel or structural member, and a variety of mechanical fasteners are used to establish this connection.

It is often necessary to connect one panel or component to another panel or to a structural portion of the vehicle. Press-fit or snap-in fasteners are frequently employed for this purpose. While conventional press-fit fasteners can provide adequate retention during initial assembly, many such designs are primarily intended for one-time installation. In service environments, it is often necessary to remove and reinstall panels for repair, inspection, or replacement of underlying components. However, existing fastening solutions generally lack do not permit controlled, nondestructive release of engagement features upon application of a defined extraction force. As a result, removal of the fastener can damage the fastener itself and/or the surrounding components, thereby limiting reusability and increasing service costs.

Additionally, certain known fasteners do not provide a controlled transition between an installed position and a service position in which the retention features are maintained in a collapsed or disengaged condition. This can result in unpredictable release forces, inconsistent service performance, or the need for destructive removal techniques.

Accordingly, there remains a need for an improved fastener assembly suitable to secure retention during normal operation while also enabling controlled, nondestructive release and repeatable serviceability.

### SUMMARY

The present disclosure relates generally to a fastening system and fastener to form a connection between components, such as automotive panels, substantially as illustrated by and described in connection with at least one of the figures, as set forth more completely in the claims.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIGS. 1a and 1b illustrate, respectively, assembly and assembled side views of an example fastening system configured to form a connection between components, in accordance with aspects of this disclosure.

FIG. 2a illustrates an underside isometric view of the removable fastener assembly shown in FIGS. 1a and 1b.

FIG. 2b illustrates an underside isometric cross-sectional view of the removable fastener assembly taken along cutline A-A (FIG. 2j).

FIG. 2c illustrates a top-side isometric view of the removable fastener assembly.

FIG. 2d illustrates a topside isometric cross-sectional view of the removable fastener assembly taken along cutline B-B (FIG. 2j).

FIG. 2e illustrates a first elevational side view of the removable fastener assembly.

FIG. 2f illustrates a second elevational side view of the removable fastener assembly.

FIG. 2g illustrates a third elevational side view of the removable fastener assembly.

FIG. 2h illustrates a fourth elevational side view of the removable fastener assembly.

FIG. 2i illustrates a second topside isometric view of the removable fastener assembly.

FIG. 2j illustrates a top plan view of the removable fastener assembly.

FIG. 2k illustrates a bottom plan view of the removable fastener assembly.

FIG. 3a illustrates a first elevational assembly side view of the removable fastener assembly.

FIG. 3b illustrates a second elevational assembly side view of the removable fastener assembly.

FIG. 3c illustrates a topside isometric assembly view of the removable fastener assembly.

FIG. 3d illustrates an underside isometric assembly view of the removable fastener assembly.

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

A removable fastener assembly, such as a pull-release snap-in retainer system or assembly, can be used to form a connection between a first component and a second component, such as automotive panels. The disclosed removable fastener assembly provides several advantages over conventional snap-in retainers, including: non-destructive disengagement of engagement features; controlled collapse of fastening wings at a defined pull force; retention of the wing structures in a serviceable position after release; reusability of the fastener for multiple service events (e.g., at least five service cycles); and an ability to partially disengage an individual fastener within a larger assembly while allowing the fastener to remain retained in the component aperture until full assembly removal.

In one example, a removable fastener assembly comprises: a clip insert including a stem extending along a center axis and at least one resilient retention member disposed at or adjacent a distal portion of the stem; and a grommet component defining a passageway configured to receive at least a portion of the clip insert, the grommet component including at least one retention feature configured to engage the clip insert, wherein the clip insert and the grommet component are axially movable relative to one another between an installed position and a release position, and wherein the at least one retention member is biased outwardly in the installed position to engage a surface defining an aperture of a component.

In some examples, application of an extraction force on the grommet component causes relative axial movement between the clip insert and the grommet component such that the grommet component urges the at least one retention member inwardly toward the center axis to permit nondestructive removal of the removable fastener assembly from the aperture.

In some examples, the grommet component comprises a flange plate and an attachment plate separated by a neck. The neck can be aligned with the center axis and maintains spacing between the flange plate and the attachment plate. The flange plate and the attachment plate can define a gap configured to receive a mounting feature of a separate component.

In some examples, the at least one retention feature of the grommet component comprises at least one flexible leg extending into the passageway.

In some examples, the stem includes at least one position feature configured to selectively engage the at least one flexible leg to define at least two discrete axial positions.

In some examples, the at least two discrete axial positions comprise a shipping position and a service position.

In some examples, the at least one position feature comprises at least one of an annular groove, a circumferential rib, a recess, or a barb formed along the stem.

In some examples, the grommet component includes at least one slot formed in a body thereof, the at least one slot permitting at least a portion of the at least one retention member to extend outwardly from the passageway.

In some examples, the at least one retention member comprises a pair of resilient wing structures disposed on opposing sides of the stem.

In some examples, each wing structure includes an angled distal tip configured to engage the surface defining the aperture.

In some examples, the grommet component includes an interface surface configured to contact the at least one retention member during relative axial movement to urge the at least one retention member inwardly.

In some examples, the grommet component includes a lead-in portion configured to facilitate insertion of the removable fastener assembly into the aperture.

In some examples, the passageway further comprises at least one alignment feature configured to cooperate with a corresponding alignment feature formed on the clip insert to guide insertion and limit relative rotational movement.

In some examples, the clip insert further comprises at least one protrusion extending radially outward from an upper portion of the clip insert and configured to frictionally engage an interior surface of the passageway.

In some examples, the at least one protrusion is configured to generate a radial preload between the clip insert and the grommet component.

In some examples, the at least one retention member is configured to be maintained in an inwardly collapsed condition when the clip insert is in the release position.

In some examples, the removable fastener further comprises a seal positioned on the grommet component.

In some examples, the seal comprises an annular structure including a flared portion configured to contact a surface of the component surrounding the aperture.

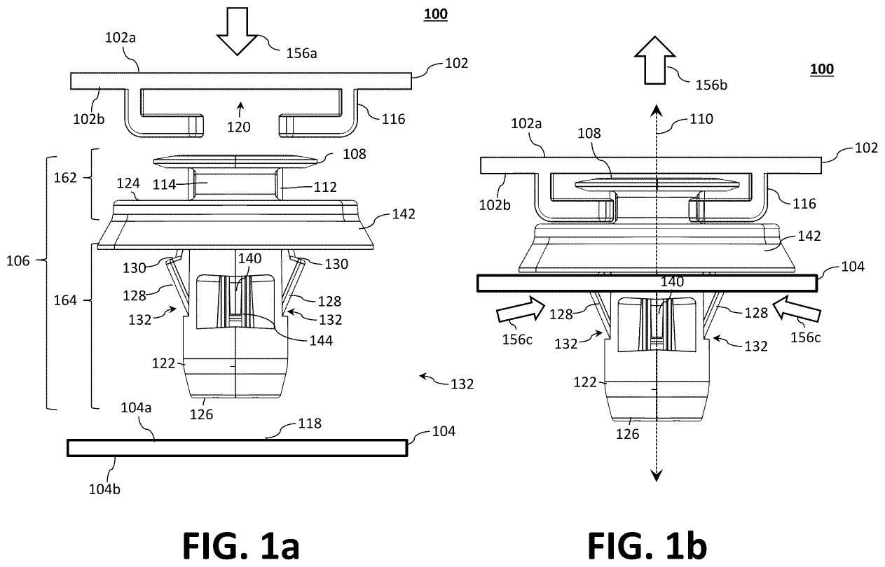

FIGS. 1a and 1b illustrate, respectively, assembly and assembled side views of an example fastening system 100 configured to form a connection between a first component 102 and a second component 104 in accordance with aspects of this disclosure. The first component 102 and the second component 104 may be, for example, automotive panels.

A removable fastener assembly 106 is provided as part of the illustrated fastening system 100 for releasably securing the first component 102 (e.g., a trim component) to the second component 104 (e.g., a panel). In one exemplary application, the removable fastener assembly 106 comprises multiple components, illustrated as a clip insert 112, a grommet component 152, and a seal 142. The seal 142 may be molded onto or press-fit onto the grommet component 152. The clip insert 112 is at least partially received within the grommet component 152 and is configured to move relatively thereto.

Depending on the application, the first component 102 and the second component 104 may be fabricated from metal (or a metal alloy), synthetic or semi-synthetic polymers (e.g., plastics, such as acrylonitrile butadiene styrene (ABS) and polyvinyl chloride (PVC)), composite materials (e.g., fiberglass), or a combination thereof. In the automotive industry, example first components 102 include, without limitation, door trim panels, moldings, trim pieces, and other substrates, whether used as interior or exterior surfaces.

The first component 102 may define an A-surface 102a and a B-surface 102b (illustrated as an undersurface). The A-surface 102a, also called a Class A surface, is typically the surface that is visible after assembly and, for that reason, is more aesthetically pleasing (e.g., textured, coated, or otherwise decorated) and typically free of attachment devices and/or related features. Conversely, the B-surface 102b, also called a Class B surface, is typically the surface that is not visible after assembly and typically includes various attachment devices and/or related features. In the illustrated example, the first component 102 defines a doghouse feature 116 having a cavity 120, while the second component 104 defines a component aperture 118.

The second component 104 may be, for example, a structural component of a vehicle, such as a door, a pillar (e.g., an A-pillar, B-pillar, C-pillar, etc.), a dashboard component (e.g., a cross member, bracket, frame, etc.), a seat frame, a center console, a fender, sheet metal framework, or the like. The second component 104 may define an A-surface 104a and a B-surface 104b (illustrated as an undersurface). Upon assembly, as best illustrated in FIG. 1b, the second component 104 is covered at least partially by the first component 102.

The removable fastener assembly 106 is configured to snap into a doghouse feature 116 formed on the first component 102. After installation into the doghouse feature 116, the assembly is insertable into a component aperture 118 formed in the second component 104 to secure the first component 102 to the second component 104. As illustrated, the removable fastener assembly 106 is attached to the B-surface 102b of the first component 102. Depending on the material type, the removable fastener assembly 106 may be attached to the B-surface 102b after fabrication of the first component 102 (e.g., via a mechanical attachment method, such as with the illustrated doghouse feature 116). While only a single removable fastener assembly 106 is illustrated, it should be appreciated that multiple fastener assemblies 106 may be used to couple the first component 102 to the second component 104, depending on the number of fastener points needed. For example, larger panels typically require multiple fastener points.

The clip insert 112 and the grommet component 152 of the removable fastener assembly 106 can form a generally rigid component assembly extending along a center axis 110. As illustrated, the removable fastener assembly 106 generally comprises a head portion 162 and a retention portion 164. In certain examples, the removable fastener assembly 106 further includes the seal 142 positioned on the grommet component 152 between the head portion 162 and the retention portion 164. The head portion 162, the retention portion 164, and, where applicable, the seal 142 may be integrally formed or provided as separate components, as described in further detail below.

The head portion 162 is configured to engage or otherwise attach to the first component 102. In the illustrated example, the head portion 162 generally defines a set of spaced-apart planar components, illustrated as a flange plate 124 and an attachment plate 108, separated by a neck 114. In the illustrated embodiment, each of the flange plate 124 and the attachment plate 108 is generally circular; however, one or both of the flange plate 124 and the attachment plate 108 may alternatively be configured in other geometries, such as quadrilateral or oval, depending on the desired application and/or shape of the doghouse feature 116. The dimensions and thicknesses of the flange plate 124 and the attachment plate 108 may be adjusted to accommodate varying load requirements or space constraints.

The head portion 162 thus comprises the flange plate 124 and the attachment plate 108 connected by the neck 114 to define a gap between the flange plate 124 and the attachment plate 108. The neck 114 extends between and integrally connects the flange plate 124 to the attachment plate 108. The illustrated neck 114 is cylindrical and maintains spacing between the flange plate 124 and the attachment plate 108 to accommodate features of the first component 102, such as the doghouse feature 116 and its cavity 120. The neck 114 is aligned along the center axis 110, which also serves as the central axis for the overall removable fastener assembly 106.

While illustrated as configured for use with the doghouse feature 116, the doghouse feature 116, the attachment plate 108, and/or the neck 114 could be omitted, and the removable fastener assembly 106, or a portion thereof, can be attached to or integrated with the first component 102 via another means. Accordingly, while the present disclosure is generally described in connection with a doghouse feature 116, the teachings of the present disclosure may be applied to other types of fasteners and attachment interfaces.

The retention portion 164 is configured to engage or otherwise attach to the second component 104. The retention portion 164 may attach to, embed within, or pass through at least a portion of the second component 104 via the component aperture 118. The component aperture 118 formed in the second component 104 defines a size and shape that is complementary to that of the retention portion 164 such that the retention portion 164 can be inserted and retained therein. In one example, the component aperture 118 can be generally circular (e.g., a round hole) and/or a slot (e.g., a narrow rectangular opening).

The grommet component 152 includes a generally cylindrical body 122 and defines a grommet passageway 148 (e.g., an internal cavity extending through the body 122) configured to receive the clip insert 112. The grommet passageway 148 extends through the body 122 and is configured to receive the clip insert 112. The illustrated grommet component 152 includes a plurality of flexible legs 140 configured to retain the clip insert 112 within the grommet passageway 148. The grommet passageway 148 further comprises one or more alignment features, illustrated as a pair of opposed linear rails 160 formed on an inner surface of the grommet passageway 148, configured to interface with corresponding alignment features formed on the clip insert 112, illustrated as a pair of opposed linear channels 158 or recesses formed along the length of a central stem 144 of the clip insert 112. This rail-and-channel interface facilitates guided insertion and rotational alignment of the clip insert 112 within the grommet component 152.

The clip insert 112 includes one or more retention members, such as wing structures 128 configured in a generally “W” configuration. The clip insert 112 is dimensioned to slide within the grommet passageway 148 of the grommet component 152. The wing structures 128 are configured to engage the aperture of the second component 104 when in an engaged position. In an example, the clip insert 112 comprises a head portion 150, the central stem 144, and the flexible wing structures 128 that are movable relative to the central stem 144. The central stem 144 extends away from and generally perpendicularly to the head portion 150 along the center axis 110. A proximal end of the central stem 144 is coupled to the head portion 150, while the flexible wing structures 128 are formed at or adjacent a distal end of the central stem 144. In certain examples, the flexible wing structures 128 of the clip insert 112 are configured as a W-base type fastener.

The retention portion 164 thus comprises the central stem 144 and at least one pair of clip wings 128 resiliently coupled to the central stem 144 at or adjacent a distal end thereof. In the illustrated embodiment, two clip wings 128 are provided, although additional or fewer clip wings 128 may be employed to meet design requirements for a given component aperture 118 size or shape.

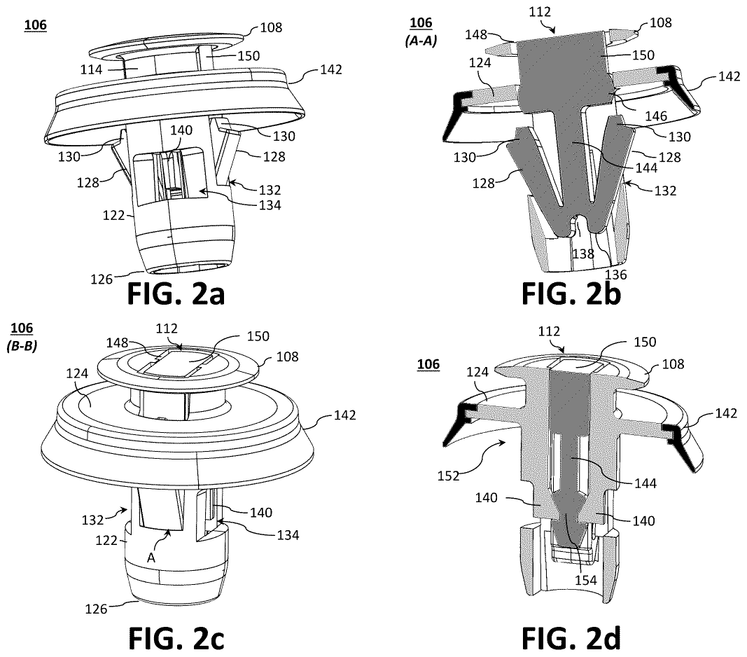

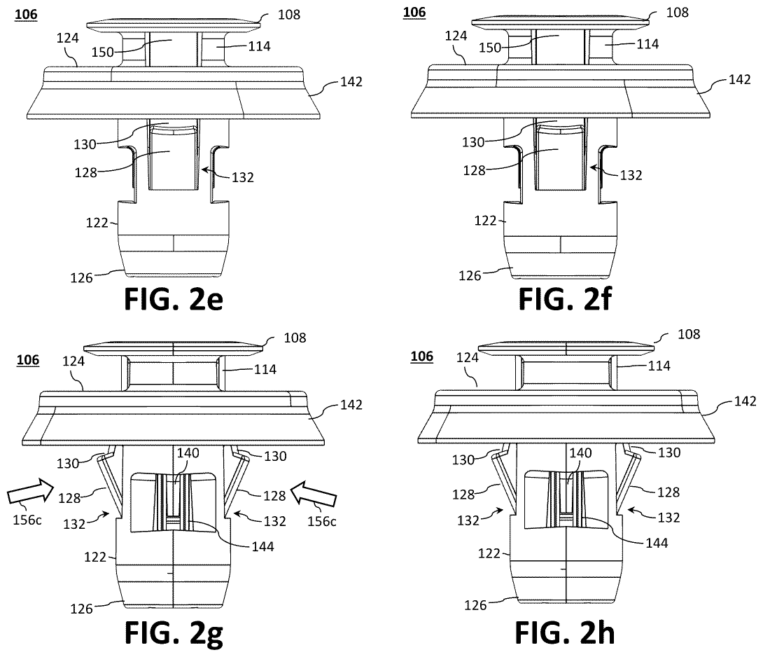

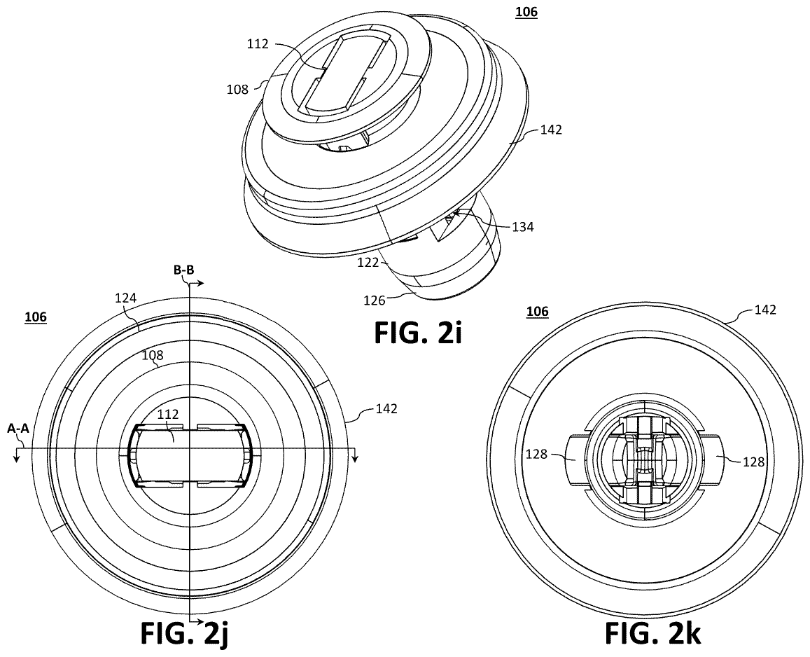

FIG. 2a illustrates an underside isometric view of the removable fastener assembly 106 of FIGS. 1a and 1b, while FIG. 2b illustrates an underside isometric cross-sectional view of the removable fastener assembly 106 taken along cutline A-A (FIG. 2j). FIG. 2c illustrates a topside isometric view of the removable fastener assembly 106, while FIG. 2d illustrates a topside isometric cross-sectional view of the removable fastener assembly 106 taken along cutline B-B (FIG. 2j). FIGS. 2e through 2h illustrate, respectively, first, second, third, and fourth elevational side views of the removable fastener assembly 106. FIG. 2i illustrates a second topside isometric view of the removable fastener assembly 106. FIGS. 2j and 2k illustrate, respectively, top and bottom plan views of the removable fastener assembly 106.

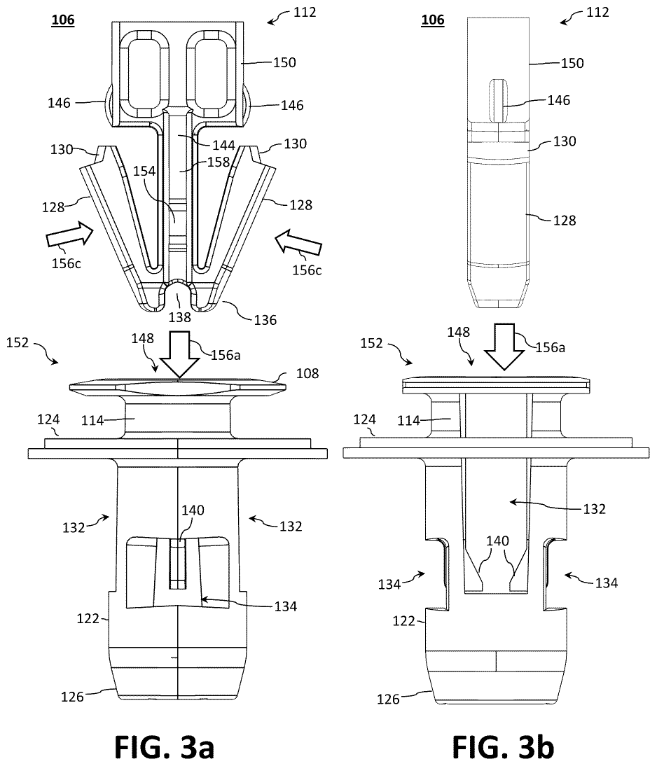

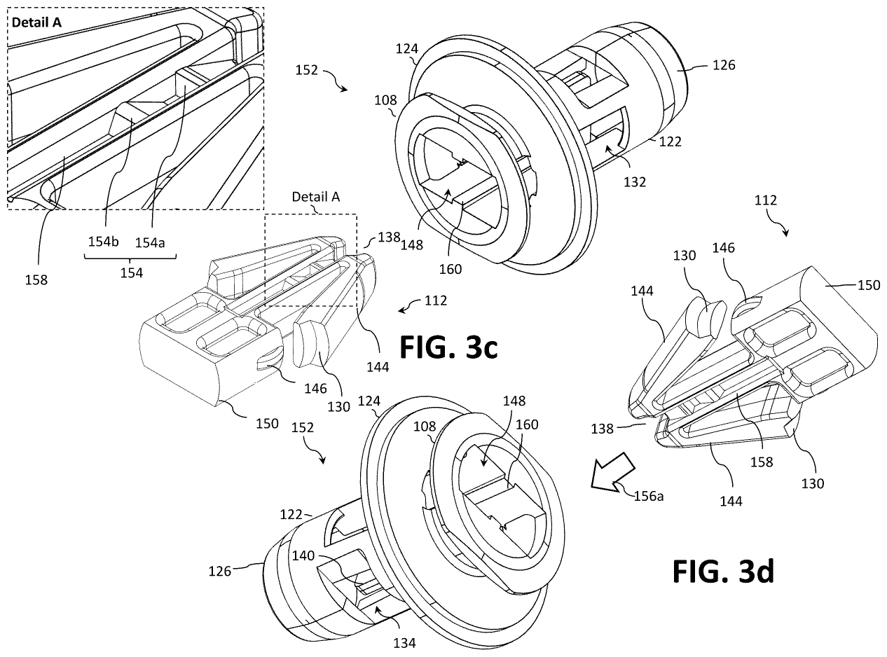

FIG. 3a illustrates a first elevational assembly side view of the removable fastener assembly 106, while FIG. 3b illustrates a second elevational assembly side view of the removable fastener assembly 106. FIGS. 3c and 3d illustrate, respectively, topside and underside isometric assembly views of the removable fastener assembly 106. For illustrative purposes, the seal 142 is omitted from the views of FIGS. 3a through 3d.

The body 122 can define a lead-in nose 126, which can be beveled or tapered to facilitate insertion of the distal end of the retention portion 164 into the component aperture 118 of the second component 104. The body 122, together with the central stem 144, serves to provide structural bracing to mitigate deformation of the retention portion 164 during installation and maintains alignment with the center axis 110.

In certain examples, the clip wings 128 extend at an angle from opposing sides of the central stem 144. Each wing 128 may include a respective wing tip 130 angled relative to the corresponding wing 128. At the distal end of the central stem 144, the wings 128 and the central stem 144 may define a nose 136. In some examples, the nose 136 includes a gap region 138, although in other examples the nose 136 may be solid and omit the gap region 138.

The body 122 of the grommet component 152 extends substantially perpendicularly from the flange plate 124 and, together with the flange plate 124, the attachment plate 108, and/or the neck 114, defines the grommet passageway 148 that provides access to an interior defined by the body 122. The body 122 further defines opposing slots 132 extending at least partially between the flange plate 124 and the lead-in nose 126. The opposing slots 132 are dimensioned to receive the wings 128 of the clip insert 112 such that the wings 128 at least partially extend from the interior of the body 122 when the clip insert 112 is received within the grommet passageway 148. In some examples, the opposing slots 132 are radially offset from lateral cutouts 134 by approximately 90 degrees, although other angular relationships may be used. The lateral cutouts 134 are positioned adjacent to the pair of flexible legs 140 and allow for the pair of flexible legs 140 the flex without obstruction from the body 122, while also mitigating excess material and weight.

When the clip insert 112 is inserted into the grommet passageway 148 of the grommet component 152, the wings 128 extend through the opposing slots 132. When both the grommet component 152 and the clip insert 112 extend through the component aperture 118 of the second component 104, the wings 128 engage a perimeter surface defining the component aperture 118. The wings 128 are biased radially outward to provide retention force. The removable fastener assembly 106 thus resists movement of the first component 102 relative to the second component 104.

When the clip insert 112 is pulled (direction of arrow 156b) with a predetermined extraction force, the wings 128 collapse or fold inward relative to the central stem 144 (center axis 110), transitioning to a disengaged state. In this manner, the W-base style wings collapse to allow service removal of the removable fastener assembly 106 from the component aperture 118 when subjected to a defined pull force.

When present, the seal 142 may be embodied as a ring, such as an annular structure, fabricated from foam material, thermoplastic, rubber, or similar sealing material. The illustrated seal 142 defines an interior surface, an exterior surface, and a flared portion. When over molded onto the flange plate 124, the surface of the flange plate 124 engages the interior surface of the seal 142. In an installed configuration, the flared portion contacts an outer surface of the second component 104 surrounding the component aperture 118.

In the assembled configuration illustrated in FIG. 1b, the flange plate 124 is positioned between the first component 102 and the second component 104. The seal 142 mitigates dust, dirt, and/or moisture penetration through the component aperture 118. The removable fastener assembly 106 may also include additional features, such as ribs or supplemental wings, to mitigate noise and/or rattle between the first and second components 102, 104.

During installation, the lead-in nose 126 is aligned with the component aperture 118, and an insertion force applied as indicated by arrow 156a to urge the removable fastener assembly 106 at least partially through the component aperture 118. In the installed configuration, the seal 142 is compressed between the first component 102 and the second component 104. The wings 128 engage the perimeter surface defining the component aperture 118 such that the retention portion 164 cooperates with the second component 104 to provide a secure, serviceable attachment between the first component 102 and the second component 104.

As best illustrated in FIGS. 3a and 3b, the central stem 144 of the clip insert 112 comprises one or more position features 154 configured to selectively engage corresponding retention features formed on the grommet component 152. As illustrated, the position features 154 can be formed linearly along the central stem 144 (e.g., in the pair of opposed linear channels 158) at one or more locations between the head portion 150 and the point at which the wings 128 are coupled to a distal end of the central stem 144. As best illustrated in Detail A of FIG. 3c, the illustrated position features 154 include a shipping position feature 154a and a service position feature 154b. In a shipping or installed position, the wing structures 128 of the clip insert 112 extend outwardly to secure the first component 102 to the second component 104.

In the illustrated embodiment, the grommet component 152 includes one or more retention features, such a pair of flexible legs 140, that are resiliently coupled to the body 122 and oriented radially inward into the cavity defined by the grommet passageway 148. The flexible legs 140 extend generally toward the center axis 110 and are positioned to engage and retain the one or more position features 154 formed in or on the central stem 144. That is, the flexible legs 140 of the grommet component 152 flex to engage and disengage the respective position features 154 during the transition between the shipping position and the service position. In this manner, axial insertion of the clip insert 112 into the grommet passageway 148 (as indicated by the direction of arrow 156a) causes the flexible legs 140 to deflect outwardly as they ride over the central stem 144 until they align with and snap into engagement with the position features 154, thereby providing a positive axial retention interface between the clip insert 112 and the grommet component 152.

The position features 154 may be formed as ramps, annular grooves, circumferential ribs, localized recesses, barbs, or other surface features that define a shoulder or engagement surface facing generally toward the head portion 150. As best illustrated in FIG. 3b, the flexible legs 140 may each include an inwardly directed engagement surface or latch feature configured to seat within or against the position features 154 once the clip insert 112 reaches a predetermined insertion depth. In some examples, the position features 154 and flexible legs 140 cooperate to define multiple retention positions, thereby permitting staged assembly, shipping position retention, or controlled service release. The resilience of the flexible legs 140 enables repeated deflection without permanent deformation, allowing the clip insert 112 to be inserted, retained, and, when subjected to a predetermined pull force, released from engagement with the grommet component 152.

When a predetermined pull force is applied to the first component 102 (and thus the grommet component 152 via the attachment plate 108) in the direction of arrow 156b, the grommet component 152 moves with the first component 102 relative to the clip insert 112. During this relative movement, an interface surface of the grommet component 152 engages the wing structures 128 of the clip insert 112, causing the wing structures 128 to collapse inwardly toward the center axis 110 in the direction of arrows 156c.

Housing interfaces (an example of which is annotated with an “A” in FIG. 2c) of the grommet component 152 (e.g., between an outer surface of the wing structures 128 and a bottom edge of the opposing slots 132) is configured to controllably collapse the wing structures 128 to a disengaged state when the defined pull force in the direction of arrow 156b is reached. Upon reaching the service position feature 154b, the wing structures 128 are maintained in a collapsed condition by the inner wall of the body 122, thereby permitting removal of the fastener from the component aperture 118 of the second component 104 without destructive damage.

The head portion 150 of the clip insert 112 can further comprise one or more protrusions 146 extending outwardly from the head portion 150 (e.g., radially away from the center axis 110). The protrusions 146 are configured to provide an interference fit with an interior surface of the grommet passageway 148, for example at or near the neck 114 or an upper region of the body 122. During insertion of the clip insert 112 into the grommet component 152, the protrusions 146 frictionally engage the interior surface of the grommet passageway 148 to stabilize the clip insert 112 and inhibit unintended axial or rotational movement relative to the grommet component 152. This interference engagement may supplement the retention provided by the position features 154 and flexible legs 140, thereby enhancing overall assembly integrity.

In certain examples, the protrusions 146 may be circumferentially spaced lobes, ribs, or raised pads formed integrally with the head portion 150. The protrusions 146 may elastically deform or cause localized elastic deformation of the surrounding grommet material upon insertion, thereby generating a radial preload between the clip insert 112 and the grommet component 152. This radial preload may reduce vibration, rattle, and noise and may also contribute to maintaining alignment of the central stem 144 along the center axis 110 within the grommet passageway 148.

While it is contemplated that the components of the removable fastener assembly 106 (e.g., the clip insert 112 and the grommet component 152) would be separately manufactured as integral components via a plastic injection molding process, other materials and/or processes are contemplated, such as additive manufacturing techniques. Using additive manufacturing techniques, components can be printed with great accuracy and with numerous details, which is particularly advantageous, for example, in creating components requiring complex and/or precise features. In addition, additive manufacturing techniques obviate the need for mold tooling typically associated with plastic injection molding, thereby lowering up-front manufacturing costs, which is particularly advantageous in low-volume production. In some examples, components of the removable fastener assembly 106 may be fabricated using material extrusion (e.g., fused deposition modeling (FDM)), stereolithography (SLA), selective laser sintering (SLS), material jetting, binder jetting, powder bed fusion, directed energy deposition, vat photopolymerization, and/or any other suitable type of additive manufacturing/3D printing process.

Additive manufacturing techniques print objects in three dimensions; therefore, both the minimum feature size (i.e., resolution) of the X-Y plane (horizontal resolution) and the layer height in the Z-axis (vertical resolution) are considered in overall printer resolution. Horizontal resolution is the smallest movement the printer's extruder can make within a layer on the X-and Y-axes, while vertical resolution is the minimal thickness of a layer that the printer produces in one pass. Printer resolution describes layer thickness and X-Y resolution in dots per inch (DPI) or micrometers (μm). The particles (3D dots) in the horizontal resolution can be around 50 to 100 μm (approximately 510 to 250 DPI) in diameter. Typical layer thickness (vertical resolution) is around 100 μm (approximately 250 DPI), although the layers may be as thin as 16 μm (approximately 1,600 DPI). The smaller the particles, the higher the horizontal resolution (i.e., the higher the detail the printer produces). Similarly, the smaller the layer thickness in the Z-axis, the higher the vertical resolution (i.e., the smoother the printed surface will be). A printing process at a higher vertical resolution, however, will take longer to produce finer layers, as the printer must produce more layers. In some examples, the first component 102 and the removable fastener assembly 106 may be formed or otherwise fabricated at different resolutions during a printing operation. For example, the removable fastener assembly 106 portion may be printed at a higher resolution than that of the first component 102, or vice versa, as needed for a particular application.

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, blocks and/or components of the disclosed examples may be combined, divided, rearranged, and/or otherwise modified. Therefore, the present method and/or system is not limited to the particular implementations disclosed. Instead, the present method and/or system includes all implementations falling within the scope of the appended claims, both literally and under the doctrine of equivalents.

What is claimed:

1. A removable fastener assembly comprising:
a clip insert including a stem extending along a center axis and at least one resilient retention member disposed at or adjacent a distal portion of the stem; and
a grommet component defining a passageway configured to receive at least a portion of the clip insert, the grommet component including at least one retention feature configured to engage the clip insert,
wherein the clip insert and the grommet component are axially movable relative to one another between an installed position and a release position, and
wherein the at least one retention member is biased outwardly in the installed position to engage a surface defining an aperture of a component.

2. The removable fastener assembly of claim 1, wherein application of an extraction force on the grommet component causes relative axial movement between the clip insert and the grommet component such that the grommet component urges the at least one retention member inwardly toward the center axis to permit nondestructive removal of the removable fastener assembly from the aperture.

3. The removable fastener assembly of claim 1, wherein the grommet component comprises a flange plate and an attachment plate separated by a neck.

4. The removable fastener assembly of claim 3, wherein the neck is aligned with the center axis and maintains spacing between the flange plate and the attachment plate.

5. The removable fastener assembly of claim 3, wherein the flange plate and the attachment plate define a gap configured to receive a mounting feature of a separate component.

6. The removable fastener assembly of claim 1, wherein the at least one retention feature of the grommet component comprises at least one flexible leg extending into the passageway.

7. The removable fastener assembly of claim 6, wherein the stem includes at least one position feature configured to selectively engage the at least one flexible leg to define at least two discrete axial positions.

8. The removable fastener assembly of claim 7, wherein the at least two discrete axial positions comprise a shipping position and a service position.

9. The removable fastener assembly of claim 7, wherein the at least one position feature comprises at least one of an annular groove, a circumferential rib, a recess, or a barb formed along the stem.

10. The removable fastener assembly of claim 1, wherein the grommet component includes at least one slot formed in a body thereof, the at least one slot permitting at least a portion of the at least one retention member to extend outwardly from the passageway.

11. The removable fastener assembly of claim 1, wherein the at least one retention member comprises a pair of resilient wing structures disposed on opposing sides of the stem.

12. The removable fastener assembly of claim 11, wherein each wing structure includes an angled distal tip configured to engage the surface defining the aperture.

13. The removable fastener assembly of claim 1, wherein the grommet component includes an interface surface configured to contact the at least one retention member during relative axial movement to urge the at least one retention member inwardly.

14. The removable fastener assembly of claim 1, wherein the grommet component includes a lead-in portion configured to facilitate insertion of the removable fastener assembly into the aperture.

15. The removable fastener assembly of claim 1, wherein the passageway further comprises at least one alignment feature configured to cooperate with a corresponding alignment feature formed on the clip insert to guide insertion and limit relative rotational movement.

16. The removable fastener assembly of claim 1, wherein the clip insert further comprises at least one protrusion extending radially outward from an upper portion of the clip insert and configured to frictionally engage an interior surface of the passageway.

17. The removable fastener assembly of claim 16, wherein the at least one protrusion is configured to generate a radial preload between the clip insert and the grommet component.

18. The removable fastener assembly of claim 1, wherein the at least one retention member is configured to be maintained in an inwardly collapsed condition when the clip insert is in the release position.

19. The removable fastener assembly of claim 1, further comprising a seal positioned on the grommet component.

20. The removable fastener assembly of claim 19, wherein the seal comprises an annular structure including a flared portion configured to contact a surface of the component surrounding the aperture.
